(19) United States
(12) Patent Application Publication
(10) Pub. No.: US 2011/0262714 A1
(43) Pub. Date: Oct. 27, 2011

(54) PRESS FELT AND METHOD FOR PRODUCING THE SAME

(76) Inventors: Andrew Allum, Lancashire (GB); John Jeffery, Blackburn (GB); Stephen Douglas, Lancashire (GB); David Stuart Ponton, Blackburn (GB); Antony Morton, Ilkley (GB)

(21) Appl. No.: 13/012,207

(22) Filed: Jan. 24, 2011

Related U.S. Application Data
(63) Continuation of application No. PCT/EP2009/058897, filed on Jul. 13, 2009.

(30) Foreign Application Priority Data
Jul. 24, 2008 (DE) 10 2008 040 706.2

(51) Int. Cl. B32B 3/00; B29C 47/00; B32B 38/14

(52) U.S. Cl. 428/195.1; 156/277; 156/244.11

(57) ABSTRACT

A method to produce a press felt for a fiber web producing and/or processing machine, including the steps of a) providing a load bearing base structure, which is, for example, produced of yarns, b) providing a first and a second non-woven fiber layer, c) imprinting a polymer material pattern onto the first or second non-woven fiber layer so that the polymer material pattern partially covers the layer, d) arranging the first non-woven fiber layer on one side of the base structure and e) arranging the second non-woven fiber layer on the first non-woven fiber layer in such a manner that the polymer material pattern is arranged between the two non-woven fiber layers. The present invention further relates to a press felt manufactured according to the method of the present invention.

### CROSS REFERENCE TO RELATED APPLICATIONS

This is a continuation of PCT application No. PCT/EP2009/058897, entitled “PRESS FELT AND METHOD FOR PRODUCING SAME”, filed Jul. 24, 2008, which is incorporated herein by reference.

### BACKGROUND OF THE INVENTION

1. Field of the Invention

The present invention relates to a press felt for a paper, cardboard or tissue machine, as well as to a method for producing the press felt.

2. Description of the Related Art

As a rule, press felts are composed of a load bearing woven or laid base structure and one or more non-woven fiber layers arranged on both sides of the base structure and needle bonded with same. In order to reduce remoistening in press felts of this type it was previously suggested to install a pre-manufactured polymer material membrane between two non-woven fiber layers that are arranged on top of each other. Manufacture of such membranes is extensive and therefore costly.

What is needed in the art is a press felt which can be produced more cost effectively. In addition it is desirable to be able to localize the adjustment of the dewatering behavior in press felts.

### SUMMARY OF THE INVENTION

The present invention provides a press felt and a method for efficiently and cost effectively producing same.

According to a first aspect of the present invention, there is provided a method of producing a press felt for a fiber web producing and/or processing machine, the method including the following steps:

a) providing a load bearing base structure, which is, for example, produced of yarns;

b) providing a first and a second non-woven fiber layer;

c) imprinting a polymer material pattern onto one side of a first or second non-woven fiber layer so that the polymer material pattern partially covers this side;

d) arranging the first non-woven fiber layer on one side of the base structure; and

e) arranging the second non-woven fiber layer on the first non-woven fiber layer in such a manner that the side which is printed with the polymer material pattern faces the other side of the two non-woven fiber layers which are arranged on each other, and bonding of the two non-woven fiber layers.

By providing a printed polymer material pattern which is arranged in the area of transition of two immediately sequential non-woven fiber layers, the dewatering behavior of the press felt can be adjusted according to the prevailing demands put upon the press felt. Due to the fact that the pattern is applied to one side of one of the two non-woven fiber layers by means of a printing process, the pattern is firmly bonded with one of the non-woven fiber layers.

The first and the second non-woven fiber layer are, for example, arranged on the side of the press felt facing the paper side of the base structure.

In order to apply the polymer material pattern efficiently and cost effectively, the non-woven fiber layer may be provided in the form of a continuous loop and it may be printed while the non-woven fiber layer is moved under the applicator device. The non-woven fiber layer itself should possess sufficient rigidity to be able to be printed in this type of process. One embodiment of the present invention therefore provides that step d) is implemented before step c) and that the polymer material pattern is printed onto the first non-woven fiber layer in step c). In other words, this means that i) the first non-woven fiber layer is arranged first on the base structure and is bonded with it before ii) the thus achieved arrangement is printed with the polymer material pattern on the free side of the first, non-woven fiber layer, before iii) the second non-woven fiber layer is arranged on the first, already printed non-woven fiber layer and is bonded with it so that the free side of the first non-woven fiber layer which is printed with the pattern faces the second non-woven fiber layer, meaning that the pattern is arranged in the area of transition between the two non-woven fiber layers which are arranged on each other.

In this context, the first non-woven fiber layer which is arranged directly on the base structure is, for example, thinner than the second non-woven fiber layer which is arranged on top of the first non-woven fiber layer. In addition, according to a second embodiment of the present invention, the first non-woven fiber layer which is arranged directly on the base structure is, for example, composed of finer fibers than the second non-woven fiber layer, which is arranged on top of the first non-woven fiber layer.

According to a third embodiment of the present invention, it is conceivable that the imprinted polymer material solidifies in a step f). Solidification of the polymer material may occur through thermal and/or chemical activation of the polymer material, depending upon the type of the polymer material which was printed on the non-woven fiber layer. In the case of silicon this can, for example, be solidified through thermal activation by means of IR radiation. If the polymer material is, for example, UV hardening polyurethane it can be solidified, for example, by means of UV radiation. It is also conceivable that the polymer material is printed onto one of the non-woven fiber layers by means of a rotary screen printing process.

It is also conceivable to apply the polymer material print onto one of the non-woven fiber layers by means of an extrusion die process. If an extrusion die or a rotary print screen are used then in step c) the non-woven fiber layer and the extrusion die or respectively the rotary print screen may be moved relative to each other in a longitudinal direction and/or in a cross direction of the non-woven fiber layer. With a rotary print screen this can occur, for example, in that it revolves relative to the non-woven fiber layer in a continuous helix-like path from one longitudinal edge of the non-woven fiber layer to the other longitudinal edge of the non-woven fiber layer on the free side of the non-woven fiber layer which has to be printed. If the pattern is applied, for example, by means of an extrusion die it is conceivable that the non-woven fiber layer and the extrusion die are moved relative to each other during the printing of pattern elements and/or between printing of sequential pattern elements. In a rotary print screen process, the pattern elements are established by the shape and arrangement of the perforations in the surface area of the rotary screen. In contrast, the pattern elements in an extrusion die process are established by the relative movement between the non-woven fiber layer and extrusion die.

In order to provide an improved elasticity of compression for the press felt of the present invention in reoccurring loads in the press nip, the polymer material, may include, or consist of, polyurethane. However, it is also conceivable for some applications that the polymer material may include or consist of, silicone.

According to a second embodiment of the present invention, there is provided a press felt for a fiber web producing and/or processing machine with a load bearing base structure, which is, for example, produced of yarns, and at least two non-woven fiber layers arranged on each other on one side of the base structure, whereby a polymer material pattern is printed on one side of one of the two non-woven fiber layers which are arranged on each other, covering this side partially and whereby the side which is printed with the pattern faces the other of the two non-woven fiber layers which are arranged on each other.

The first of the two non-woven fiber layers which are arranged on each other is, for example, arranged directly on the base structure and the second of the two non-woven fiber layers which are arranged on each other is arranged on the first non-woven fiber layer.

In this context, the second non-woven fiber layer may provide either the paper contact side of the press felt or be arranged underneath at least one additional non-woven fiber layer representing the paper contact side of the press felt. The second non-woven fiber layer in the latter scenario is arranged between the first non-woven fiber layer and the at least one additional non-woven fiber layer.

The polymer material pattern is printed, for example, on one side of the first non-woven fiber layer.

It is also conceivable that on the non-woven fiber layer which provides the paper contact side of the press felt an additional polymer material pattern is printed on the paper contact side. In addition, it is also possible that additional polymer material patterns are provided which are arranged between consecutive non-woven fiber layers. The following variations are, for example, conceivable:

1. Base structure—first non-woven fiber layer—polymer material pattern—second non-woven fiber layer—additional polymer material pattern;

2. Base structure—first non-woven fiber layer—polymer material pattern—second non-woven fiber layer—additional polymer material pattern—non-woven fiber layer; and

3. Base structure—first non-woven fiber layer—polymer material pattern—second non-woven fiber layer—first additional polymer material pattern—non-woven fiber layer—second additional polymer material pattern—non-woven fiber layer.

It is self evident that all of the aforementioned principles can be combined with each other as desired.

The polymer material pattern, for example, covers between 5% and 90%, or between 20% and 60%, or between 35% and 55% of the area of the printed side of the non-woven fiber layer.

Depending upon the application purpose, the polymer material pattern may be formed either by a plurality of polymer pattern elements, arranged uniformly relative to each other, or that the polymer material pattern is formed by a plurality of polymer pattern elements, arranged irregularly relative to each other. Also conceivable is a combination, meaning that the polymer material pattern is formed by a plurality of polymer pattern elements which are arranged uniformly relative to each other and by a plurality of polymer pattern elements which are arranged irregularly relative to each other.

The polymer pattern elements of the polymer material pattern may all be of the same shape and size. It is also conceivable that at least some of the elements of the pattern differ from each other in regard to shape and/or size.

The polymer pattern elements may have a height in the range of approximately 0.1-2.0 mm.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 illustrates a cross section of one design form of a press felt according to the present invention.

The exemplification set out herein illustrates embodiment of the invention and such exemplification is not to be construed as limiting the scope of the invention in any manner.

### DETAILED DESCRIPTION OF THE INVENTION

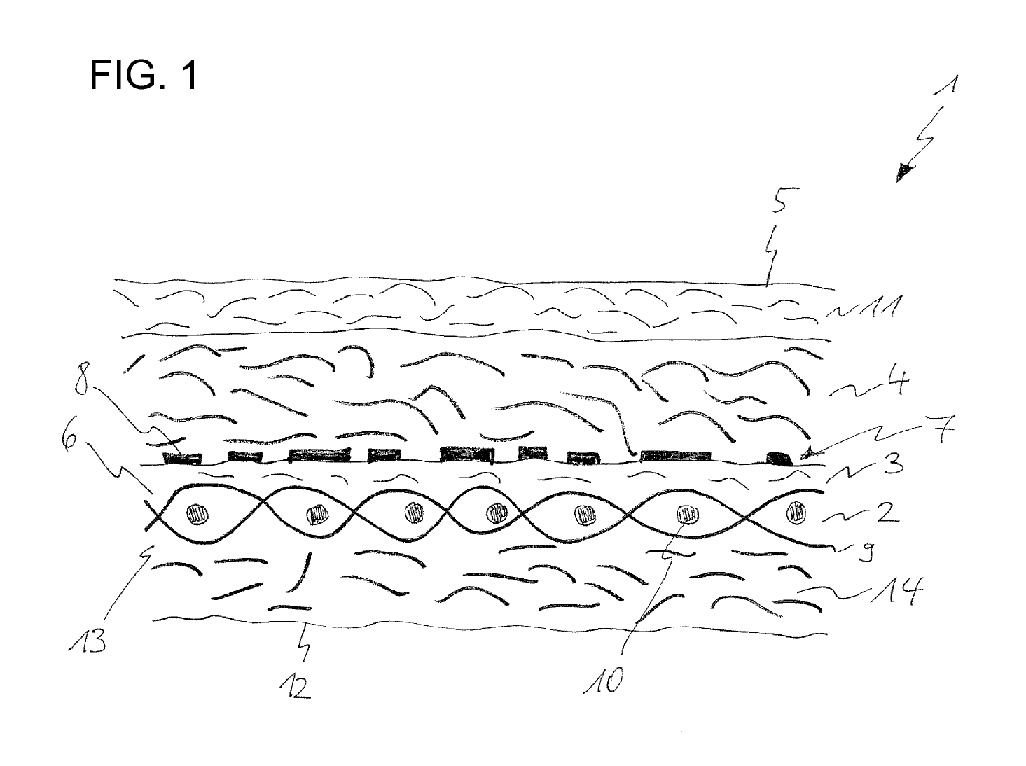

Referring now to the drawings, and more particularly to FIG. 1, there is shown press felt 1 which includes a load bearing base structure which is formed by woven structure 2, as well as first non-woven fiber layer 3 and second non-woven fiber layer 4. First and second fiber layer 3, 4 are arranged on each other on side 6 of base structure 2 which faces paper side 5 of press felt 1. Woven structure 2 is formed by longitudinal yarns 9 and cross yarns 10 which are interwoven. According to the present invention, pattern 7 consisting of polymer pattern elements 8 is arranged between non-woven fiber layers 3, 4, which are arranged on each other and which are covered partially by the pattern which, in the current example, is printed on first non-woven fiber layer 3.

Above second non-woven fiber layer 4, an additional non-woven fiber layer 11 is arranged which represents paper side 5. As can be seen, first non-woven fiber layer 3 consists of finer fibers than second non-woven fiber layer 4.

In the manufacture of press felt 1, first non-woven fiber layer 3 was first positioned on base structure 2 and bonded with it, before the thus obtained arrangement was printed with polymer material pattern 7 on the free side of first non-woven fiber layer 3. After imprinting first non-woven fiber layer 3 with pattern 7, second non-woven fiber layer 4, and on it additional non-woven fiber layer 11, were arranged on first already imprinted non-woven fiber layer 3 and bonded with it so that polymer material pattern 7 is arranged between first and second non-woven fiber layer 3, 4.

In the current example, polymer material pattern 7 covers between approximately 30% and 50% of the surface of the printed side.

In the current example, at least some of polymer pattern elements 8 of pattern 7 differ from each other in shape and size, whereby pattern elements 8 are arranged irregularly relative to each other. In addition, polymer pattern elements 8 have a height in the range of approximately 0.1-2.0 mm.

In the current example, the first of the two non-woven fiber layers 3 which are arranged on each other is positioned directly on base structure 2. In addition, the second of the two non-woven fiber layers 4 which are arranged on each other is positioned on first non-woven fiber layer 3. On side 13 of base structure 2 which faces machine side 12 of press felt 1, non-woven fiber layer 14 is arranged which provides machine side 12 of press felt 1.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method to produce a press felt for at least one of a fiber web producing machine and a fiber web processing machine, the method comprising the steps of:
a) providing a load bearing base structure;
b) providing a first non-woven fiber layer and a second non-woven fiber layer;
c) imprinting a polymer material pattern onto one side of one of said first non-woven fiber layer and said second non-woven fiber layer such that said polymer material pattern partially covers said one side;
d) arranging said first non-woven fiber layer on one side of said base structure; and
e) arranging said second non-woven fiber layer on said first non-woven fiber layer such that said one side printed with said polymer material pattern faces the other of said first non-woven fiber layer and said second non-woven fiber layer.

2. The method according to claim 1, wherein said load bearing base structure is produced from a plurality of yarns.

3. The method according to claim 1, wherein said step d) is implemented before said step
c) and said polymer material pattern is printed on said first non-woven fiber layer in said step c).

4. The method according to claim 2, further comprising a step f) causing said imprinted polymer material to solidify.

5. The method according to claim 4, wherein said polymer material is imprinted with a screen printing process.

6. The method according to claim 4, wherein said polymer material is applied onto one of said first non-woven fiber layer and said second non-woven fiber layer with an extrusion die process.

7. The method according to claim 6, wherein during said imprinting step c) said one of said first non-woven fiber layer and said second non-woven fiber layer having and an extrusion die of said extrusion die process are moved relative to each other in at least one of a longitudinal direction and a cross direction of said one of said first non-woven fiber layer and said second non-woven fiber layer.

8. The method according to claim 7, wherein said one of said first non-woven fiber layer and said second non-woven fiber layer and said extrusion die are moved relative to each other at least one of during printing of a plurality of pattern elements and between printing of a plurality of sequential pattern elements.

9. The method according to claim 1, wherein said polymer material at least includes polyurethane.

10. A press felt for at least one of a fiber web producing and a fiber web processing machine, the press felt comprising:
a load bearing base structure;
a first non-woven fiber layer;
a second non-woven fiber layer arranged on said first non-woven fiber layer, said first fiber layer and said second fiber layer being arranged on one side of said base structure;
a polymer material pattern printed on one side of one of said first fiber layer and said second fiber layer, said polymer material partially covering said one side, wherein said one printed side of said one of said first fiber layer and said second fiber layer faces the other of said first fiber layer and said second fiber layer.

11. The press felt according to claim 10, wherein said load bearing structure is formed of a plurality of yarns.

12. The press felt according to claim 11, wherein said first fiber layer is arranged directly on said base structure and said second fiber layer is arranged on said first fiber layer.

13. The press felt according to claim 12, wherein said second fiber layer one of provides a paper contact side of the press felt and is arranged underneath at least one additional non-woven fiber layer forming said paper contact side of the press felt.

14. The press felt according to claim 13, wherein said polymer material pattern is printed on a side of said first fiber layer.

15. The press felt according to claim 14, further comprising a second polymer material pattern printed on said paper contact side.

16. The press felt according to claim 15, wherein said polymer pattern covers between approximately 5% and 90% of an area of a surface of said printed side.

17. The press felt according to claim 16, wherein said polymer pattern covers between approximately 20% and 60% of said surface of said printed side.

18. The press felt according to claim 17, wherein said polymer material pattern is formed by a plurality of polymer pattern elements arranged relative to each other.

19. The press felt according to claim 17, wherein said polymer material pattern is formed by a plurality of pattern elements arranged irregularly relative to each other.

20. The press felt according to claim 19, wherein said polymer pattern elements have a height in a range of approximately 0.1 mm to 2.0 mm.
